(19) United States
(12) Patent Application Publication
(10) Pub. No.: US 2003/0100466 A1
(43) Pub. Date: May 29, 2003

(54) Liquid diswashing detergent compositions containing amylase enzymes

(76) Inventors: Peter Robert Foley, Cincinnati, OH (US); Bruce Prentiss Murch, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/891,000

(22) PCT Filed: Feb. 8, 2000
(86) PCT No.: PCT/US00/03227

(51) Int. Cl. C11D 3/386; C11D 3/00

(52) U.S. Cl. 510/392; 510/530

(57) ABSTRACT

Liquid dishwashing detergent composition containing one or more amylase enzymes and a suds booster which exhibits excellent greasy soil removal performance and are either of a high pH of greater than about 8.

### TECHNICAL FIELD

The present invention relates to liquid dishwashing detergent compositions containing amylase enzymes and which exhibit excellent greasy soil removal performance and having a high pH of greater than about 8.

### BACKGROUND OF THE INVENTION

Light-duty liquid (LDL) or gel detergent compositions useful for manual dishwashing are well known in the art. Such products are generally formulated to provide a number of widely diverse performance and aesthetics properties and characteristics. First and foremost, liquid or gel dishwashing products must be formulated with types and amounts of surfactants and other cleaning adjuvants that will provide acceptable solubilization and removal of food soils, especially grease, fat and other hydrophobic soils, from dishware being cleaned with aqueous solutions of these dishwashing products.

Heavily soiled dishware can present special problems during manual dishwashing operations. Kitchen articles such as plates, utensils, pots, pans, crockery and the like may be heavily soiled in the sense that relatively large amounts of food soils and residues, particularly polymerized and burnt-on greasy soils, may still be found on the dishware at the time such soiled dishware is to be manually washed. Such soil residues may be tenaciously adhered or stuck to the surfaces of the dishware to be cleaned as the result of the food soils present, the nature of the dishware surfaces involved or even the type of cooking operations to which the soiled dishware had been subjected. Starch-based soils are particularly prone to become tenaciously adhered to the side of kitchenware. Thus, there is a continuing effort by formulators of liquid dishwashing compositions to incorporate additional components into LDL detergents to provide consumers with improved cleaning benefits, particularly on the difficult, baked and burnt-on soils which make cleaning kitchenware laborious.

One such component which can improve cleaning performance on tenacious soils is amylase enzymes. As a component of a liquid dishwashing detergent, amylase enzymes can be extremely effective at removing starch-based soils and residues adhered to kitchen articles such as cookware and dishware.

But while amylase enzymes provide excellent cleaning benefits, it has been difficult to successfully incorporate amylases into a liquid dishwashing detergent formulation because the enzymes tend to be unstable and rapidly degrade, leaving the formulation's amylase enzyme constant at levels far too low to provide adequate cleaning benefits. Thus upon prolonged storage, the formulation's starch-cleaning performance will gradually deteriorate as the amylase enzymes degrade to levels insufficient to provide starch-cleaning benefits.

Given the foregoing, there is a continuing need to formulate manual dishwashing compositions that have improved amylase enzyme stability. Accordingly, it is a benefit of the present invention to provide liquid dishwashing compositions that have excellent amylase enzyme stability and thus provide excellent cleaning benefits even after prolonged storage.

### SUMMARY OF THE INVENTION

It has now been determined in the present invention that improved cleaning performance may be obtained when the amylase enzyme is added to a liquid dishwashing detergent composition having a relatively alkaline pH of at least 8, preferably at least 9. This improved cleaning performance is obtained whether or not the amylase enzyme-destabilizing compounds discussed above are excluded or kept to very low levels.

Thus the present invention relates to a liquid dishwashing detergent composition comprising: (a) from about 0.0001% to about 5%, of an amylase enzyme; and (b) at least about 0.5% of a suds booster; wherein the composition has a pH of greater than about 8, preferably greater than about 9 and the detergent composition has especially desirable greasy soil removal performance when used to clean heavily soiled kitchen articles.

All parts, percentages and ratios used herein are expressed as percent weight unless otherwise specified. All documents cited are, in relevant part, incorporated herein by reference. Unless otherwise noted all pH values reported for a composition are as measured as 10% aqueous solution.

### DETAILED DESCRIPTION OF THE INVENTION

Definitions—As used herein the term “light duty liquid detergent composition” (LDL) refers to those compositions which are employed in manual (i.e. hand) dishwashing.

By “kitchen articles” it is meant cookware, flatware, dishware, silverware and other articles commonly found in the kitchen and used for the preparation, consumption and serving of food as well as those articles used for cleaning up at the conclusion of a meal or other food preparation.

Enzymes

Detergent compositions of the present invention comprise at least one amylase enzyme and (if desirable) other enzymes which provide cleaning performance benefits.

Amylase—Amylases (α and/or β) can be included for removal of carbohydrate-based stains. Suitable amylases are Termamyl® (Novo Nordisk), Fungamyl® and BAN® (Novo Nordisk). The enzymes may be of any suitable origin, such as vegetable, animal, bacterial, fungal and yeast origin. Amylase enzymes are normally incorporated in the detergent composition at levels from about 0.0001% to about 2%, preferably from about 0.0001% to about 0.5%, more preferably from about 0.0005% to about 0.1%.

In one embodiment of the present invention, amylase enzymes are used at very low levels: from about 0.0001% to about 0.05%, preferably from about 0.0002% to about 0.02%. Based on experience with other enzyme species, it would seem that the use of such small amounts of amylase enzymes would not enhance cleaning efficacy; but it has been determined in the present invention that appreciable cleaning benefits are obtained even at these low levels.

When enzymes are used in a liquid dishwashing composition. at very low levels, in order to prevent such small amounts of enzyme from becoming quickly destabilized and destroyed it is preferable that certain enzyme destabilizing ingredients (discussed in greater detail below) are excluded from the liquid dishwashing composition.

Amylase enzymes also include those described in WO95/26397 and in co-pending application by Novo Nordisk PCT/DK96/00056. Other specific amylase enzymes for use in the detergent compositions of the present invention therefore include:

(a) α-amylases characterised by having a specific activity at least 25% higher than the specific activity of Termamyl® at a temperature range of 25° C. to 55° C. and at a pH value in the range of 8 to 10, measured by the Phadebas® α-amylase activity assay. Such Phadebas® α-amylase activity assay is described at pages 9-10, WO95/26397.

(b) α-amylases according (a) comprising the amino sequence shown in the SEQ ID listings in the above cited reference. or an α-amylase being at least 80% homologous with the amino acid sequence shown in the SEQ ID listing.

(c) a-amylases according (a) obtained from an alkalophilic Bacillus species, comprising the following amino sequence in the N-terminal : His-His-Asn-Gly-Thr-Asn-Gly-Thr-Met-Met-Gln-Tyr-Phe-Glu-Trp-Tyr-Leu-Pro-Asn-Asp.

A polypeptide is considered to be X % homologous to the parent amylase if a comparison of the respective amino acid sequences, performed via algorithms, such as the one described by Lipman and Pearson in Science 227, 1985, p. 1435, reveals an identity of X %

(d) α-amylases according (a-c) wherein the a-amylase is obtainable from an alkalophilic Bacillus species; and in particular, from any of the strains NCIB 12289, NCIB 12512, NCIB 12513 and DSM 935.

In the context of the present invention, the term “obtainable from” is intended not only to indicate an amylase produced by a Bacillus strain but also an amylase encoded by a DNA sequence isolated from such a Bacillus strain and produced in an host organism transformed with said DNA sequence.

(e) α-amylase showing positive immunological cross-reactivity with antibodies raised against an α-amylase having an amino acid sequence corresponding respectively to those α-amylases in (a-d).

(f) Variants of the following parent α-amylases which (i) have one of the amino acid sequences shown in corresponding respectively to those α-amylases in (a-e), or (ii) displays at least 80% homology with one or more of said amino acid sequences, and/or displays immunological cross-reactivity with an antibody raised against an α-amylase having one of said amino acid sequences, and/or is encoded by a DNA sequence which hybridizes with the same probe as a DNA sequence encoding an α-amylase having one of said amino acid sequence; in which variants:

1. at least one amino acid residue of said parent α-amylase has been deleted; and/or

2. at least one amino acid residue of said parent α-amylase has been replaced by a different amino acid residue; and/or

3. at least one amino acid residue has been inserted relative to said parent α-amylase; said variant having an cc-amylase activity and exhibiting at least one of the following properties relative to said parent α-amylase : increased thermostability, increased stability towards oxidation, reduced Ca ion dependency, increased stability and/or α-amylolytic activity at neutral to relatively high pH values, increased α-amylolytic activity at relatively high temperature and increase or decrease of the isoelectric point (pI) so as to better match the pI value for α-amylase variant to the pH of the medium. Said variants are described in the patent application PCT/DK96/00056.

Other amylases suitable herein include, for example, α-amylases described in GB 1,296,839 to Novo; RAPIDASE®, International Bio-Synthetics, Inc. and TERMAMYL®. Novo. FUNGAMYL® from Novo is especially useful. Engineering of enzymes for improved stability, e.g., oxidative stability, is known. See, for example J. Biological Chem., Vol. 260, No. 11. June 1985, pp. 6518-6521. Certain preferred embodiments of the present compositions can make use of amylases having improved stability in detergents such as automatic dishwashing types. especially improved oxidative stability as measured against a reference-point of TERMAMYL® in commercial use in 1993. These preferred amylases herein share the characteristic of being “stability-enhanced” amylases, characterized, at a minimum, by a measurable improvement in one or more of: oxidative stability, e.g., to hydrogen peroxide/tetraacetylethylenediamine in buffered solution at pH 9-10; thermal stability, e.g., at common wash temperatures such as about 60° C.: or alkaline stability, e.g., at a pH from about 8 to about 11, measured versus the above-identified reference-point amylase. Stability can be measured using any of the art-disclosed technical tests. See, for example, references disclosed in WO 9402597. Stability-enhanced amylases can be obtained from Novo or from Genencor International. One class of highly preferred amylases herein have the commonality of being derived using site-directed mutagenesis from one or more of the Bacillus amylases, especially the Bacillus α-amylases, regardless of whether one, two or multiple amylase strains are the immediate precursors. Oxidative stability-enhanced amylases vs. the above-identified reference amylase are preferred for use, especially in bleaching, more preferably oxygen bleaching, as distinct from chlorine bleaching, detergent compositions herein. Such preferred amylases include (a) an amylase according to the hereinbefore incorporated WO 9402597, Novo, Feb. 3, 1994, as further illustrated by a mutant in which substitution is made, using alanine or threonine, preferably threonine, of the methionine residue located in position 197 of the B. licheniformis alpha-amylase, known as TERMAMYL®, or the homologous position variation of a similar parent amylase, such as B. amyloliquefaciens, B. subtilis, or B. stearothermophilus; (b) stability-enhanced amylases as described by Genencor International in a paper entitled “Oxidatively Resistant alpha-Amylases” presented at the 207th American Chemical Society National Meeting, March 13-17 1994, by C. Mitchinson. Therein it was noted that bleaches in automatic dishwashing detergents inactivate alpha-amylases but that improved oxidative stability amylases have been made by Genencor from B. licheniformis NCIB8061. Methionine (Met) was identified as the most likely residue to be modified. Met was substituted, one at a time, in positions 8, 15, 197, 256, 304, 366 and 438 leading to specific mutants, particularly important being M197L and M197T with the M197T variant being the most stable expressed variant. Stability was measured in CASCADE® and SUNLIGHT®; (c) particularly preferred amylases herein include amylase variants having additional modification in the immediate parent as described in WO 9510603 A and are available from the assignee, Novo, as DURAMYL®. Other particularly preferred oxidative stability enhanced amylase include those described in WO 9418314 to Genencor International and WO 9402597 to Novo. Any other oxidative stability-enhanced amylase can be used, for example as derived by site-directed mutagenesis from known chimeric, hybrid or simple mutant parent forms of available amylases. Other preferred enzyme modifications are accessible. See WO 9509909 A to Novo.

Other Enzymes—Although amylase enzymes provide excellent cleaning benefits when included in a detergent composition, it is preferred that they be used as one part of a cocktail of conventional applicable enzymes like protease, amylase, lipase, cutinase and/or cellulase. Enzymes when present in the compositions, at from about 0.0001% to about 5% of active enzyme by weight of the detergent composition. Other enzymes suitable for use in the present invention include cellulases, hemicellulases, peroxidases, proteases, lipases, cutinases, pectinases, xylanases, reductases, oxidases, phenoloxidases. lipoxygenases, ligninases, pullulanases, tannases, pentosanases, malanases, β-glucanases, arabinosidases or mixtures thereof. Preferred proteolytic enzymes, then, are selected from the group consisting of Alcalase® (Novo Industri A/S), BPN′, Protease A and Protease B (Genencor), and mixtures thereof. Protease B is most preferred.

Further non-limiting examples of suitable and preferred enzymes are disclosed in U.S. Pat. No. 5,990,065, to Vinson et al., issued Nov. 23, 1999, which is hereby incorporated by reference.

Composition pH

As measured as 10% aqueous solution, the compositions of the present invention will have a pH of at least about 8, preferably at least about 9, more preferably at least about 9.5. Preferably the pH of the present detergent compositions will be less than about 12, more preferably less than about 11. Amylase enzymes are especially effective as part of a high pH detergent composition. Without intending to be limited by theory it is believed that the increased efficacy of amylases at high pH is because amylase enzymes are effective only against hydrated soils and the increased alkalinity of the detergent composition increases the hydration of the tenacious, baked-on starch soils thereby increasing the catalysis of starch hydrolysis. Furthermore, high pH detergent compositions improves overall dish cleaning performance, regardless of the presence of amylase enzymes, because the higher pH environment increases elimination of soil materials by hydrolysis Those hydrolyzed soils which are not completely eliminated are typically loosened and softened to such a degree that amylase enzymes, as well as other cleaning adjuvants, can more readily work to eliminate them.

The benefits of a more alkaline detergent composition to enhance the effectiveness of amylase enzyme on eliminating starch soils are obtained with or without the reduced levels of amylase enzyme-destabilizing compounds (i.e. amine oxide, hydrogen peroxide, citric acid and citrates etc.) as discussed elsewhere in this invention.

But dishwashing compositions of the invention will be subjected to acidic stresses created by food soils when put to use, i.e.. diluted and applied to soiled dishes; so if a composition with a pH greater than 8 or 9 is to be more effective, it preferably should contain a buffering agent capable of providing a generally more alkaline pH in the composition and in dilute solutions. Dishwashing compositions of the present invention will thus contain from about 0.1% to 15%, preferably from about 1% to 10%, most preferably from about 2% to 8%, by weight, of a buffering agent. The pKa value of this buffering agent should be about 0.5 to 1.0 pH units below the desired pH value of the composition (with the pKa value determined as described above). Under these conditions the buffering agent most effectively controls the pH while using the least amount thereof.

The buffering agent may be an active detergent in its own right, or it may be a low molecular weight, organic or inorganic material that is used in this composition solely for maintaining an alkaline pH. Preferred buffering agents for compositions of this invention are nitrogen-containing materials. Some examples are amino acids such as lysine or lower alcohol amines like mono-, di-, and tri-ethanolamine. The diamines, described in detail above, also act as buffering agents and are preferred buffering agents. Preferred inorganic buffers/alkalinity sources include the alkali metal carbonates, alkali metal hydroxides and alkali metal phosphates, e.g., sodium carbonate, sodium hydroxide, sodium polyphosphate.

Preferred buffering system for use in the present detergent compositions include a combination of 0.5% diamine and 2.5% citrate and a combination of 0.5% diamine, 0.75% potassium carbonate and 1.75% sodium carbonate. Other preferred nitrogen-containing buffering agents are Tri(hydroxymethyl)amino methane (HOCH₂)₃CNH₃ (TRIS), 2-amino-2-ethyl-1,3-propanediol, 2-amino-2-methyl-propanol, 2-amino-2-methyl-1,3-propanol, disodium glutamate, N-methyl diethanolamide, 1,3-diamino-propanol N,N′-tetra-methyl-1,3-diamino-2-propanol, N,N-bis(2-hydroxyethyl)glycine (bicine) and N-tris (hydroxymethyl)methyl glycine (tricine). Mixtures of any of the above are also acceptable. For additional buffers see McCutcheon's EMULSIFIERS AND DETERGENTS, North American Edition, 1997, McCutcheon Division, MC Publishing Company Kirk and WO 95/07971 both of which are incorporated herein by reference.

Surfactants

The compositions of this invention comprise from about 5% to about 90%, more preferably from about 25% to about 70% by weight surfactant.

Anionic Surfactants—The anionic surfactants useful in the present invention are preferably selected from the group consisting of linear alkylbenzene sulfonate, alpha olefin sulfonate, paraffin sulfonates, alkyl ester sulfonates, alkyl sulfates, alkyl alkoxy sulfate, alkyl sulfonates, alkyl alkoxy carboxylate, alkyl alkoxylated sulfates, sarcosinates, taurinates, and mixtures thereof. An effective amount, typically from about 0.5% to about 90%, preferably about 5% to about 50%, more preferably from about 10 to about 30%, by weight of anionic detersive surfactant can be used in the present invention.

Suitable examples of anionic surfactants may be found in copending provisional patent application of Chandrika Kasturi et al., entitled “Liquid Detergent Compositions Comprising Polymeric Suds Enhancers”, having P & G Case No. 6938P, Ser. No. 60/066,344 and filed on Nov. 21, 1997, which is hereby incorporated by reference. Further examples of suitable anionic surfactants are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23. Suitable anionic surfactants may further be found in U.S. Pat. No. 5,415,814 issued May 16, 1995, to Ofosu-Asante et al., all of which are hereby incorporated by reference.

Amphoteric surfactants—The amphoteric surfactants useful in the present invention are preferably selected from amine oxide surfactants. Amine oxides are semi-polar nonionic surfactants and include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Semi-polar amphoteric detergent surfactants including amine oxide surfactants are discussed in greater detail in U.S. Pat. No. 5,167,872, issued Dec. 1, 1992, to Pancheri et al. These amine oxide surfactants in particular include C₁₀-C₁₈ alkyl dimethyl amine oxides and C₈-C₁₂ alkoxy ethyl dihydroxy ethyl amine oxides.

Also suitable are amine oxides such as propyl amine oxides, represented by the formula:

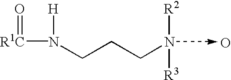

wherein R₁ is an alkyl. 2-hydroxyalkyl. 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10.

Other suitable, non-limiting examples of amphoteric detergent surfactants that are useful in the present invention include amido propyl betaines and derivatives of aliphatic or heterocyclic secondary and ternary amines in which the aliphatic moiety can be straight chain or branched and wherein one of the aliphatic substituents contains from about 8 to about 24 carbon atoms and at least one aliphatic substituent contains an anionic water-solubilizing group.

Further examples of suitable amphoteric surfactants are given in “Surface Active Agents and Detergents” (Vol. I and II by Schwartz, Perry and Berch), hereby incorporated by reference.

Preferably the amphoteric surfactant is present in the composition in an effective amount, more preferably from about 0.1% to about 20%, even more preferably about 0.1% to about 15%, even more preferably still from about 0.5% to about 10%, by weight.

Nonionic Surfactants—Examples of nonionic detergent surfactants that are useful in the present invention are generally disclosed in U.S. Pat. No. 3,929,678, Laughlin et al., issued Dec. 30, 1975, at column 13, line 14 through column 16, line 6, incorporated herein by reference. These include:

(i) the polyethylene, polypropylene, and polybutylene oxide condensates of alkyl phenols.;

(ii) alcohol ethoxylates which are the condensation products of aliphatic alcohols with from about 1 to about 25 moles of ethylene oxide. They are represented by the general formula:

R(OCH₂CH₂)ₙOH

(iii) another type of nonionic co-surfactant suitable for use in combination with the polyhydroxy fatty acid amides in the nonionic surfactant component herein comprises the ethylene oxide-propylene oxide block co-polymers that function as polymeric surfactants (these are also discussed separately under the solvents heading);

(iv) the condensation products of ethylene oxide with a hydrophobic base formed by the condensation of propylene oxide with propylene glycol; and

(v) alkylpolysaccharides disclosed in U.S. Pat. No. 4,565,647, Llenado, issued Jan. 21, 1986, having a hydrophobic group containing from about 6 to about 30 carbon atoms, preferably from about 10 to about 16 carbon atoms and a polysaccharide.

Secondary Surfactants—Secondary detersive surfactant can be selected from the group consisting of cationics, ampholytics, zwitterionics, and mixtures thereof. By selecting the type and amount of detersive surfactant, along with other adjunct ingredients disclosed herein, the present detergent compositions can be formulated to be used in the context of laundry cleaning or in other different cleaning applications, particularly including dishwashing. The particular surfactants used can therefore vary widely depending upon the particular end-use envisioned. Suitable secondary surfactants are described in detail in the copending provisional patent application of Chandrika Kasturi et al., entitled “Liquid Detergent Compositions Comprising Polymeric Suds Enhancers”, having P & G Case No. 6938P, application Ser. No. 60/066,344, incorporated above.

Diamines—Diamines used herein in detergent compositions in combination with detersive surfactants at levels and ratios (discussed in further detail below) which are effective for achieving at least a directional improvement in cleaning performance. In the context of a hand dishwashing composition, such “usage levels” can vary depending not only on the type and severity of the soils and stains, but also on the wash water temperature, the volume of wash water and the length of time the dishware is contacted with the wash water.

Since the habits and practices of the users of detergent compositions show considerable variation, the composition will preferably contain at least about 0.1%, more preferably at least about 0.2%, even more preferably, at least about 0.25%, even more preferably still, at least about 0.5% by weight of said composition of diamine. The composition will also preferably contain no more than about 15%, more preferably no more than about 10%, even more preferably, no more than about 6%, even more preferably, no more than about 5%, even more preferably still, no more than about 1.5% by weight of said composition of diamine.

In one of its several aspects, this invention provides a means for enhancing the removal of greasy/oily soils by combining the specific diamines of this invention with surfactants. Greasy/oily “everyday” soils are a mixture of triglycerides, lipids, complex polysaccharides, fatty acids, inorganic salts and proteinaceous matter.

Thus diamines, in combination with amphoteric and anionic surfactants in the specific ratios discussed below, offer the benefit of improved grease and tough food cleaning which allows the elimination or reduction in the amount of divalent ions in the preferred embodiments of the present formula. This improved cleaning is a result of diamines' proclivity as a buffering agent to increase the alkalinity of the dishwashing composition.

It is preferred that the diamines used in the present invention are substantially free from impurities. That is, by “substantially free” it is meant that the diamines are over 95% pure, i.e., preferably 97%, more preferably 99%, still more preferably 99.5%, free of impurities. Examples of impurities which may be present in commercially supplied diamines include 2-Methyl-1,3-diaminobutane and alkylhydropyririidine. Further, it is believed that the diamines should be free of oxidation reactants to avoid diamine degradation and ammonia formation.

As is discussed in greater detail below, making the compositions free of hydrogen peroxide is important when the compositions contain an enzyme. Even small amounts of hydrogen peroxide can cause problems with enzyme containing formulations. However, the diamine can react with any peroxide present and act as an enzyme stabilizer and prevent the hydrogen peroxide from reacting with the enzyme. The only draw back of this stabilization of the enzymes by the diamine is that the nitrogen compounds produced are believed to cause the malodors which can be present in diamine containing compositions. Having the diamine act as an enzyme stabilizer also prevents the diamine from providing the benefits to the composition for which it was originally put in to perform, namely, grease cleaning, sudsing, dissolution and low temperature stability. Therefore, it is preferred to minimize the amount of hydrogen peroxide present as an impurity in the inventive compositions either by using components which are substantially free of as an enzyme stabilizer, because of the possible generation of hydrogen peroxide and/or by using non-diamine antioxidants even though the diamine can act malodorous compounds and the reduction in the amount of diamine available present to perform its primary role.

Preferred organic diamines are those in which pK1 and pK2 are in the range of about 8.0 to about 11.5, preferably in the range of about 8.4 to about 11, even more preferably from about 8.6 to about 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=1 1; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines.

As a working definition herein, the pKa of the diamines is specified in an all-aqueous solution at 25° C. and for an ionic strength between 0.1 to 0.5 M. The pKa is an equilibrium constant which can change with temperature and ionic strength; thus, values reported in the literature are sometimes not in agreement depending on the measurement method and conditions. To eliminate ambiguity, the relevant conditions and/or references used for pKa's of this invention are as defined herein or in “Critical Stability Constants: Volume 2, Amines”. One typical method of measurement is the potentiometric titration of the acid with sodium hydroxide and determination of the pKa by suitable methods as described and referenced in “The Chemist's Ready Reference Handbook” by Shugar and Dean, McGraw Hill, NY, 1990.

It has been determined that substituents and structural modifications that lower pK1 and pK2 to below about 8.0 are undesirable and cause losses in performance. This can include substitutions that lead to ethoxylated diamines, hydroxy ethyl substituted diamines, diamines with oxygen in the beta (and less so gamma) position to the nitrogen in the spacer group (e.g., Jeffamine EDR 148). In addition, materials based on ethylene diamine are unsuitable.

The diamines useful herein can be defined by the following structure:

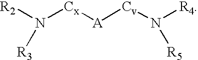

wherein R₂₋₅ are independently selected from H, methyl, —CH₃CH₂, and ethylene oxides; Cₓ and Cᵥ are independently selected from methylene groups or branched alkyl groups where x+y is from about 3 to about 6; and A is optionally present and is selected from electron donating or withdrawing moieties chosen to adjust the diamine pKa's to the desired range. If A is present, then x and y must both be 1 or greater.

Specific diamines suitable for use in the present invention are discussed in greater detail in U.S. Pat. No. 5,990,065, to Vinson et al., issued Nov. 23, 1999, which is hereby incorporated by reference.

Ratio of anionic to amphoteric to diamine—In a preferred embodiment of the present invention, the LDL compositions contain anionic surfactant, amphoteric surfactants, and diamine in a ratio of anionic: amphoteric: diamine from about 100:40:1 to about 9:0.5: 1, by mole. preferably the ratio of the anionic: amphoteric: diamine is from about 27:8:1 to about 11:3:1, by mole. It has been found that detergent compositions containing anionic surfactant, amphoteric surfactant and diamine in this specific ratio range provide improved low temperature stability, deliver better grease removal and tough food cleaning benefits as well as improved hard water cleaning.

Calcium Or Magnesium Ions—The presence of calcium and/or magnesium (divalent) ions improves the cleaning of greasy soils for various compositions, i.e. compositions containing alkyl ethoxy carboxylates and/or polyhydroxy fatty acid amide. This is especially true when the compositions are used in softened water that contains few divalent ions. It is believed that calcium and/or magnesium ions increase the packing of the surfactants at the oil/water interface, thereby reducing interfacial tension and improving grease cleaning.

Compositions of the invention hereof containing magnesium and/or calcium ions exhibit good grease removal, manifest mildness to the skin, and provide good storage stability.

Preferably, the magnesium or calcium ions are added as a hydroxide, chloride, acetate, formate, oxide or nitrate salt to the compositions of the present invention.

The amount of calcium or magnesium ions present in compositions of the invention will be dependent upon the amount of total surfactant present therein, including the amount of alkyl ethoxy carboxylates and polyhydroxy fatty acid amide. When calcium ions are present in the compositions of this invention, the molar ratio of calcium ions to total anionic surfactant is from about 0.25:1 to about 2:1 for compositions of the invention.

Formulating such divalent ion-containing compositions in alkaline pH matrices may be difficult due to the incompatibility of the divalent ions, particularly magnesium, with hydroxide ions. When both divalent ions and alkaline pH are combined with the surfactant mixture of this invention, grease cleaning is achieved that is superior to that obtained by either alkaline pH or divalent ions alone. Yet, during storage, the stability of these compositions becomes poor due to the formation of hydroxide precipitates. Therefore, chelating agents discussed herein below may also be necessary.

The ions are present in the compositions hereof at an active level of from about 0.1% to 4%, preferably from about 0.3% to 3.5%, more preferably from about 0.5% to 1%, by weight.

Although either species of divalent ion provides benefits when included in a detergent composition, preferably the detergent compositions of the present invention contain no calcium ions.

Solvents—The present liquid detergent compositions contain either diols or polymeric glycols or a mixture of both diols and polymeric glycols (polymeric glycols are composed of ethylene oxide (EO) and propylene oxide (PO) groups). In addition to diols and polymeric glycols, a variety of other water-miscible liquids such as lower alkanols, diols, other polyols, ethers, amines, and the like may be used in the present invention. Particularly preferred are the C1-C4 alkanols. Suitable solvents are discussed in greater detail in the provisional patent application of Clarke et al., entitled “Diols and Polymeric Glycols for Improved Dishwashing Detergent Compositions”, having P & G Case No. 7408 provisional serial No. 60/119,044, filed on Feb. 8, 1999, which is hereby incorporated by reference.

When present the composition will preferably contain at least about 0.01%, more preferably at least about 0.5%, even more preferably still, at least about 1% by weight of the composition of solvent. The composition will also preferably contain no more than about 20%, more preferably no more than about 10%, even more preferably, no more than about 8% by weight of the composition of solvent.

Suds Booster—Another component which may be included in the composition of this invention is a suds stabilizing surfactant (suds booster) at a level of at least about 0.5%, preferably at least about 2%, more preferably at least about 5%. The composition will also contain no more than about 20%, preferably no more than about 15%, more preferably, no more than about 10% of said suds booster.

Suds stabilizing surfactants operable in the instant composition are: sultanas, complex betaines, betaines, ethylene oxide condensates, fatty acid amides, amine oxide semi-polar nonionics, and cationic surfactants. Also suitable as suds boosters are the polymeric suds stabilizers disclosed in the provisional application of Clarke et al., entitled “Diols and Polymeric Glycols for Improved Dishwashing Detergent Compositions”, having P & G Case No. 7408 provisional serial No. 60/119,044, filed on Feb. 8, 1999, which is hereby incorporated by reference.

Builder (Chelants)—The compositions according to the present invention may further comprise builders. A general description of builder materials is contained in U.S. Pat. No. 5,990,065, to Vinson et al., issued Nov. 23, 1999, which is hereby incorporated by reference. If detergency builder salts are included, they will be included in amounts of from 0.5% to 50% by weight of the composition preferably from 5% to 30% and most usually from 5% to 25% by weight.

Other Ingredients—The detergent compositions will further preferably comprise one or more detersive adjuncts selected from the following: soil release polymers, polymeric dispersants, polysaccharides, abrasives, bactericides and other antimicrobials, tarnish inhibitors, builders, enzymes, dyes, buffers, antifungal or mildew control agents, insect repellents, perfumes, hydrotropes, thickeners, processing aids, brighteners, anti-corrosive aids, stabilizers antioxidants and chelants. A wide variety of other ingredients useful in detergent compositions can be included in the compositions herein, including other active ingredients, carriers, hydrotropes, antioxidants, processing aids, dyes or pigments, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultanas noted above is also advantageous.

Composition Form and Method of Usage

Composition Form—The present liquid dishwashing detergent compositions may optionally be in the form of either a microemulsion or a bicontinuous microemulsion. By “microemulsion” or “conventional microemulsion” it is meant a thermodynamically stable mixture of oil and water in which a discontinuous domain is suspended in a continuous domain. The discontinous domain is in the form of spherical droplets having radii of between 100 and 1000 Å. When the discontinuous domain is oil and the continuous domain is water, it is an oil-in-water microemulsion. When the discontinuous domain is water and the continuous domain is oil, it is a water-in-oil microemulsion. See Surfactant Science Series, Volume 6: Emulsions and Emulsion Technology Part 1 (edited by Kenneth J. Lissant), p. 127. Marcel Dekker, New York (1974); Surfactant Science Series, Volume 66: Industrial Applications of Emulsions (edited by Conxita Solans et al.), p.2. Marcel Dekker, New York (1997).

By “bicontinuous microemulsion” it is meant a thermodynamically stable mixture of oil and water wherein two continuous, interconnecting and separate domains, separated by a surfactant interface, are present rather than there being both a continuous and a discontinuous domain. A bicontinuous microemulsion is classified as a Winsor Type III microemulsion. P. A. Winsor, Chem. Rev. 68, p. 3-6 (1968); Surfactant Science Series, Volume 6: Emulsions and Emulsion Technology Part 1 (edited by Kenneth J. Lissant), p. 191-92 Marcel Dekker, New York (1997). Surfactant Science Series, Volume 66: Industrial Applications of Emulsions (edited by Conxita Solans et al.), p. 158, Marcel Dekker, New York (1997).

When the detergent compositions are present in the form of a microemulsion or bicontinuous microemulsion, they will comprise (in addition to a selection of the ingredients described above): (a) a microemulsion-forming solvent; (b) a liquid hydrocarbon component; and (c) an aqueous liquid carrier. Suitable examples of each of these components as well as overwell formulation directions are discussed in the provisional patent application of Mark L. Kacher et al., entitled “Light Duty Liquid Dishwashing Compositions in the Form of Microemulsions”, filed on Apr. 8, 1999, having Ser. No. 60/128,351 and P&G Case No. 7504P, which is hereby incorporated by reference.

Method of Usage—The compositions of this invention can be used to form aqueous washing solutions for use hand dishwashing. Generally, an effective amount of such compositions is added to water to form such aqueous cleaning or soaking solutions. The aqueous solution so formed is then contacted with the dishware, tableware, and cooking utensils.

An effective amount of the detergent compositions herein added to water to form aqueous cleaning solutions can comprise amounts sufficient to form from about 500 to 20,000 ppm of composition in aqueous solution. More preferably, from about 800 to 5,000 ppm of the detergent compositions herein will be provided in aqueous cleaning liquor.

The following examples are illustrative of the present invention, but are not meant to limit or otherwise define its scope. All parts, percentages and ratios used herein are expressed as percent weight unless otherwise specified.

The following examples are illustrative of the present invention, but are not meant to limit or otherwise define its scope. All parts, percentages and ratios used herein are expressed as percent weight of the composition unless otherwise specified.

TABLE I
A light-duty liquid dishwashing detergent
formula having the following composition is prepared:

| | Example 1 | Example 2 | Example 3 | Example 4 | Example 5 |
|---|---|---|---|---|---|
| AES¹ | 27.0 | 26.0 | 20.0 | 26.0 | 20 |
| Amine | 6.5 | 7.0 | 4.0 | — | 6.0 |
| oxide² | | | | | |
| Nonionic³ | 2.4 | 3.0 | 2.0 | 3.5 | 3.0 |
| Diamine⁴ | 0.6 | 1.0 | 0.5 | — | — |
| Suds | 0.8 | 1.0 | 0.5 | — | 0.7 |
| boosting | | | | | |
| polymer⁵ | | | | | |
| Poly- | 1.4 | 1.5 | 1.0 | — | 10.0 |
| propylene | | | | | |
| glycol | | | | | |
| Ethanol | 6.0 | 5.8 | 2.0 | 5.6 | |
| Amylase | 0.002 | 0.005 | 0.0005 | 0.002 | 0.001 |
| NaOH | to pH 8.5 | to pH 9.5 | to pH 9.0 | to pH 9.0 | to pH 8.5 |
| Limonene | — | — | — | — | 8.0 |
| Water and | Balance | Balance | Balance | Balance | Balance |
| Misc. | | | | | |

¹C₁₂₋₁₃ alkyl ethoxy sulfonate containing an average of 0.6 ethoxy groups.
²C₁₂-C₁₄ Amine oxide.
³Nonionic may be either C₁₁ Alkyl ethoxylated surfactant containing 9 ethoxy groups or C₁₀ Alkyl ethoxylated surfactant containing 8 ethoxy groups.
⁴1,3 bis(methylamine)-cyclohexane
⁵Polymer is (N,N-dimethylamino)ethyl methacrylate homopolymer

What is claimed is:

1. A liquid dishwashing detergent composition characterized by:
(a) from 0.0001% to 5%, of an amylase enzyme; and
(b) at least 0.5% of a suds booster;
wherein the composition has a pH of greater than 8 and the detergent composition has especially desirable greasy soil removal performance when used to clean heavily soiled kitchen articles.

2. A liquid dishwashing detergent composition according to claim 1 is further characterized by an enzyme selected from the group consisting of cellulases, hemicellulases, peroxidases, proteases, gluco-amylases, lipases, cutinases, pectinases, xylanases, reductases, oxidases, phenoloxidases, lipoxygenases, ligninases, pullulanases, tannases, pentosanases, malanases, β-glucanases, arabinosidases and mixtures thereof.

3. A liquid dishwashing detergent composition according to any of claims 1-2 wherein the amylase enzyme has a specific activity at least 25% higher than the specific activity of Termamylâ at a temperature range of 25° C. to 55° C. and at a pH value in the range of 8 to 10, measured by the Phadebasâ a-amylase activity assay.

4. A liquid dishwashing detergent composition according to any of claims 1-3 further characterized by a low molecular weight organic diamine having a pK1 and a pK2, wherein the pK1 and the pK2 of said diamine are both in the range of from 8.0 to 11.5;

5. A liquid dishwashing detergent composition according to any of claims 1-4 wherein said diamine is selected from the group consisting of: 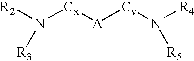
wherein R₂₋₅ are independently selected from H, methyl, ethyl, and ethylene oxides; Cₓ and Cᵥ are independently selected from methylene groups or branched alkyl groups where x+v is from 3 to 6; and A is optionally present and is selected from electron donating or withdrawing moieties chosen to adjust the diamine pKa's to the desired range; wherein if A is present, then both x and y must be 2 or greater.

6. A liquid dishwashing detergent composition according to any of claims 1-5 further characterized by a buffering agent and wherein the composition has a pH of from 10 to 11.5.

7. A liquid dishwashing detergent composition according to any of claims 1-6 wherein said diamine is selected from the group consisting of dimethyl aminopropyl amine, 1,6-hexane diamine, 1,3 propane diamine, 2-methyl 1,5 pentane diamine, 1,3-Pentanediamine, 1-methyl-diaminopropane, Jeffamine EDR 148, Isophorone diamine, 1,3-bis(methylamine)-cyclohexane and mixtures thereof.

8. A liquid dishwashing detergent composition according to any of claims 1-7 further characterized by an anionic surfactant and an amphoteric surfactant and wherein the mole ratio of said anionic surfactant to said amine oxide to said diamine is from 100:40:1 to 9:0.5:1.

9. A method for cleaning a substrate in a manual dishwashing operation characterized by the steps of:
(a) contacting the substrate with a liquid dishwashing detergent composition prepared according to any of claims 1-8; and
(b) allowing the detergent composition to remain in contact with the substrate for a sufficient time to provide effective cleaning benefits to the substrate.
